(19) United States
(12) Patent Application Publication
(10) Pub. No.: US 2015/0106587 A1
(43) Pub. Date: Apr. 16, 2015

(54) DATA REMAPPING FOR HETEROGENEOUS PROCESSOR

(71) Applicant: Advanced Micro Devices, Inc., Sunnyvale, CA (US)

(72) Inventors: Shuai Che, Bellevue, WA (US); Bradford Beckmann, Redmond, WA (US); Blake Hechtman, Bellevue, WA (US)

(73) Assignee: Advanced Micro Devices, Inc., Sunnyvale, CA (US)

(21) Appl. No.: 14/055,221

(22) Filed: Oct. 16, 2013

(51) Int. Cl. G06F 12/10

(52) U.S. Cl. CPC G06F 12/109
USPC 711/209

(57) ABSTRACT

A processor remaps stored data and the corresponding memory addresses of the data for different processing units of a heterogeneous processor. The processor includes a data remap engine that changes the format of the data (that is, how the data is physically arranged in segments of memory) in response to a transfer of the data from system memory to a local memory hierarchy of an accelerated processing module (APM) of the processor. The APM's local memory hierarchy includes an address remap engine that remaps the memory addresses of the data at the local memory hierarchy so that the data can be accessed by routines at the APM that are unaware of the data remapping. By remapping the data, and the corresponding memory addresses, the APM can perform operations on the data more efficiently.

### BACKGROUND

1. Field of the Disclosure

The present disclosure relates generally to processors and more particularly to heterogeneous processors.

2. Description of the Related Art

Early processor designs typically employed a single central processing unit (CPU) to execute instructions (e.g. computer programs) in order to carry out tasks for an electronic device. To improve performance, modern processor designs can employ a heterogeneous system architecture, whereby the processor includes both a CPU and one or more accelerated processing modules (APMs) in a common integrated circuit package. Each APM is designed to efficiently execute instructions and computations for specific types of tasks. An example of an APM is a graphics processing unit (GPU) that is employed by a processor to perform specialized graphics computations in parallel with the processor's CPU. The APMs of a heterogeneous processor typically employ different instruction set architectures (ISAs) than the processor's CPU in order to allow the APMs to carry out their specialized computations efficiently. However, these specialized architectures can reduce memory access efficiency for data accessed by both the CPU and the APMs.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system including a heterogeneous processor in accordance with some embodiments.

FIG. 2 is a diagram illustrating an example remapping of data and addresses for different processing units of the processor of FIG. 1 in accordance with some embodiments.

FIG. 3 is a diagram illustrating another example remapping of data and addresses for different processing units of the processor of FIG. 1 in accordance with some embodiments.

FIG. 4 is a block diagram of the address remap engine of FIG. 1 in accordance with some embodiments.

FIG. 5 is a block diagram of the data remap engine of FIG. 1 in accordance with some embodiments.

FIG. 6 is a flow diagram of a method of remapping data and addresses for different processing units of a processor in accordance with some embodiments.

FIG. 7 is a flow diagram illustrating a method for designing and fabricating an integrated circuit device implementing at least a portion of a component of a processing system in accordance with some embodiments.

### DETAILED DESCRIPTION OF EMBODIMENT(S)

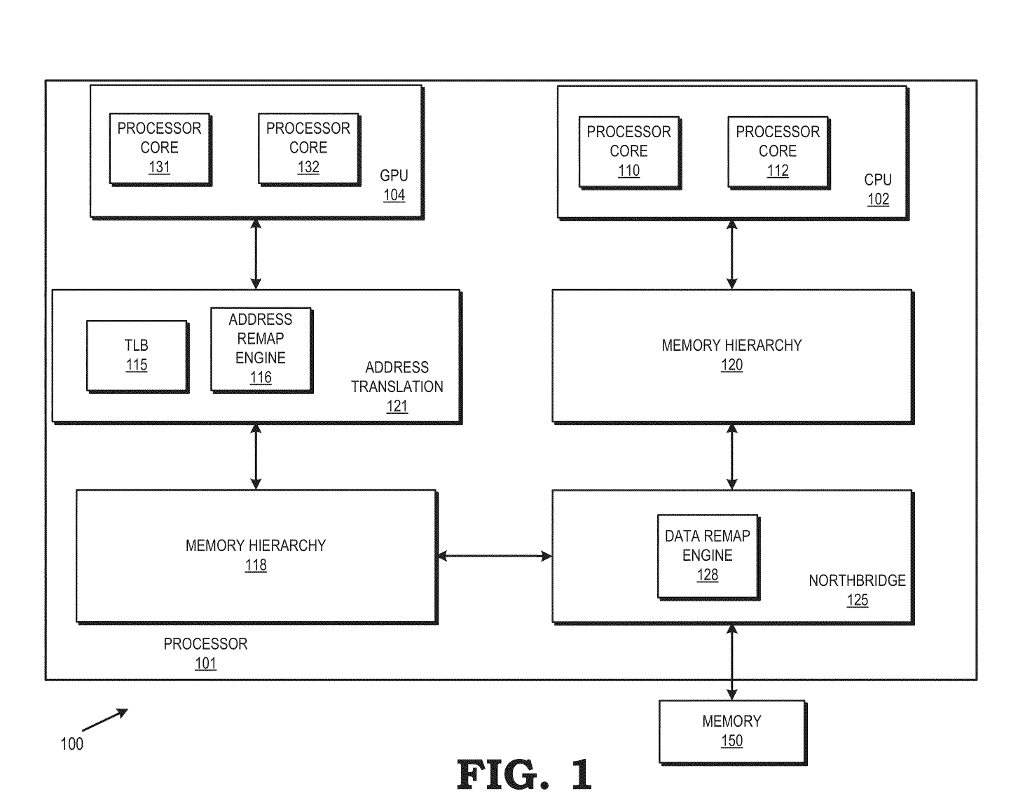

FIGS. 1-7 illustrate techniques for remapping stored data and the stored data's corresponding memory addresses for different processing units of a heterogeneous processor. In some embodiments, the different processing units comprise different types of processing units using different types of instruction set architectures. The heterogeneous processor includes a data remap engine that changes the format of the data (how the data is physically arranged in segments of memory) when that data is transferred from system memory to a local memory hierarchy of an APM of the processor. The APM's local memory hierarchy includes an address remap engine that remaps the memory addresses of the data at the local memory hierarchy so that the data can be accessed transparently by routines at the APM. By remapping the data, and corresponding memory addresses, the APM can perform operations on the data more efficiently.

To illustrate, the architecture of the APM can be such that it operates more efficiently on data stored in a particular format. For example, for certain applications, the APM may operate more efficiently on data arrays stored in a column-major format, rather than a row-major format. However, another processing unit (e.g. a CPU) of the processor may operate more efficiently on the data if the data is stored in a different format (e.g. a row-major format). Accordingly, by remapping the data when it is stored at a local memory hierarchy of the APM to a format favored by the hardware architecture of the APM and by the memory access patterns of applications running on the APM, the processor enhances the efficiency of operations at the APM without reducing the efficiency of operations at other processing units.

FIG. 1 illustrates a block diagram of a processing system 100 including a heterogeneous processor 101 in accordance with some embodiments. The processing system 100 is generally configured to execute sets of instructions in order to carry out tasks, as defined by the sets of instructions, on behalf of an electronic device. Accordingly, the processing system 100 can be part of a personal computer, server, computer-enabled telephone (e.g. a smartphone), game console or portable gaming device, tablet computer, and the like.

The processing system 100 includes a memory 150 that stores data for the processor 101. The memory 150 can be volatile memory, such as modules of random access memory (RAM), non-volatile memory such as flash memory, one or more hard disk drives, and the like, or a combination thereof. The memory 150 stores the data at memory locations, whereby each memory location is associated with a different memory address. The memory 150 is generally configured to receive memory access requests (store and load requests) including corresponding memory addresses targeted by the requests, and to execute the corresponding operations at the memory locations identified by the memory addresses. Thus, for a store request, the memory 150 is configured to store data identified by the request at the memory location corresponding to the memory address targeted by the store request. For a load request, the memory 150 is configured to provide data at the memory location corresponding to the memory address targeted by the load request.

The processing system 100 generates memory access requests in the course of executing sets of instructions. To facilitate instruction execution, the processing system 100 includes processing units 102 and 104, each configured to execute instructions according to their corresponding instruction set architecture (ISA). For purposes of description, processing unit 102 is described as a central processing unit (CPU), and processing unit 104 is described as a graphics processing unit (GPU). However, it will be appreciated that the processing units 102 and 104 can be any types of processing units having different instruction set architectures. Thus, for example, processing unit 104 could be another type of accelerated processing unit, such as a digital signal processor.

The CPU 102 and GPU 104 each includes one or more processor cores (e.g. processor cores 110 and 112 for CPU 102 and processor cores 131 and 132 for GPU 104), each configured to execute streams of instructions referred to as program threads. In at least one embodiment, the CPU 102 executes, at one or more of its processor cores, an operating system that schedules execution of program threads at each processor core, including the processor cores of the GPU 104. The processor cores can execute their threads concurrently, thereby improving processor efficiency with parallelism. In some embodiments, the concurrently executed program threads can include program threads of the same computer program. Thus, for example, the processor cores of the GPU 104 can execute GPU threads of a computer program while the processor cores of the CPU 102 concurrently execute other CPU threads of the same computer program.

Each of the CPU 102 and GPU 104 are connected to a corresponding local memory hierarchy, designated memory hierarchy 120 and memory hierarchy 118, respectively. As used herein, the term “local memory hierarchy” refers to one or more local caches or other memory structures that are only directly accessible by a corresponding processing unit and not directly accessible by other processing units of the processor. A processing unit may indirectly access the local memory hierarchy of another processing unit by requesting data through the other processing unit. In some embodiments, the memory hierarchy 120 includes system memory, such as memory 150.

As indicated above, each of the memory hierarchies 118 and 120 include memory structures, such as caches, that store data that is likely to be accessed and reused soon by their respective processing units. Each of the memory hierarchies 118 and 120 respond to memory access requests generated at their corresponding processing unit in similar fashion to the memory 150 described above. If a memory hierarchy does not store data targeted by a memory access request, it passes that memory access request to the memory 150 via a northbridge 125.

The northbridge 125 manages the transfer of memory access requests and corresponding data between the memory hierarchies 118 and 120 and between the hierarchies and the memory 150. Accordingly, the northbridge 125 can include memory controllers, buffer structures, flow controllers, coherency controllers, and the like, to facilitate communication of memory access requests, and the responses thereto, between the memory hierarchies 118 and 120 and the memory 150.

In some embodiments, the memory hierarchies 118 and 120 can include memory structures that are specially designed for the operations of their corresponding processing unit. For example, the GPU's local memory hierarchy 118 can include texture memory, scratchpad memory, and constant memory, each configured to store data and respond to memory access requests in a way that enhances the efficiency of the GPU 104. In some embodiments, one or more of these special memory structures is configured so that it operates more efficiently on data stored in a particular format. However, the format that is more efficient for a particular operation at a given processing unit, or for storage at a memory structure of the memory hierarchy thereof, may differ from the format that is more efficient for the operations at a different processing unit, or for storage at the corresponding memory hierarchy. To illustrate via an example, for certain applications, the tasks executing at the CPU 102 may most efficiently access data at the memory hierarchy 120 when that data is stored in a column-major format. In contrast, the tasks executing at the GPU 104, and accesses of that data at the memory hierarchy 118, may be most efficiently realized when the data is in a row-major format. Because the CPU 102 and the GPU 104 may operate on the same set of data, the processor 101 includes hardware structures to facilitate translation of data and its corresponding virtual memory addresses, from one format to another, according to which of the memory hierarchies 118 and 120 stores the data.

In particular, the northbridge 125 includes a data remap engine 128 that is generally configured to remap data received from the memory 150 according to a data remap rule, wherein the remap rule is identified by a memory access request or other instruction requesting the data. As described further herein, when data is requested from the memory 150 by the memory hierarchy 118, the data remap engine remaps the data to a format upon which the GPU 104 can operate more efficiently. The data is stored at the memory 150 in a format upon which the CPU 102 can operate more efficiently. Accordingly, if the data is requested by the CPU 102, the data remap engine does not remap the data and the data is transferred to the memory hierarchy 120 in the same format as it is stored at the memory 150. Thus, when the data is transferred to one of the memory hierarchies 118 and 120, it is placed in the format that is more efficient for the corresponding processing unit.

In some embodiments, the processing units 102 and 104 operate on a common virtual memory space, thereby simplifying the development of the threads executed at each processing unit. Accordingly, when each of the processing units 102 and 104 generate a memory access request, the memory access request targets a virtual memory address that is to be translated to a physical memory address. The physical memory address identifies the particular physical location, at one of the memory hierarchies 118 and 120, and the memory 150, of the data targeted by the memory access request. When data is remapped by the data remap engine 128, its physical location in memory is changed. Accordingly, the processor 101 includes hardware structures to translate virtual addresses that target remapped data so that the virtual address correctly identifies the physical location of the remapped data.

To illustrate, the GPU 104 is connected to an address translation module 121 that is generally configured to translate virtual addresses of memory access requests generated at the GPU 104 physical addresses for accessing the memory hierarchy 118. The address translation module 121 includes a translation lookaside buffer (TLB) 115 and an address remap engine 116. The TLB 115 is configured to store a mapping of the most recently accessed virtual memory addresses at the GPU 104 to their corresponding physical addresses the TLB 115 also stores information indicating whether a particular memory address corresponds to data that has been remapped. For such addresses, the address remap engine 116 translates the virtual address to a remapped virtual address so that the data can be properly accessed at the memory hierarchy 118. The address remap engine 116 thereby allows the GPU 104 and CPU 102 to operate with reference to the same virtual memory address space and refer to data using the same virtual memory addresses, thereby simplifying programming of each processing unit.

In operation, the address translation module 121 receives a virtual address from the GPU 104 corresponding to a memory access request. The address translation module 121 employs the TLB 115 to identify whether the virtual address is in a region of virtual addresses that correspond to remapped data. For example, the virtual address space of the processor 101 may be subdivided into memory pages, wherein each memory page corresponds to a range of virtual memory addresses. To simplify operation of the address translation module 121, data may be designated as remapped or not remapped on a memory page by page basis. In response to identifying that the received virtual address is not a remapped address the address translation module 121 translates the virtual address without performing any remapping at the address remap engine 116. Accordingly, the address translation module 121 first identifies whether the virtual address is located in the TLB 115. In some embodiments, the virtual address consists of a virtual page number and page offset, and the corresponding physical address consists of a physical page number and the page offset. The address translation module 121 retrieves the corresponding physical page number for the virtual page number of the virtual address from the TLB 115, provides the physical address (the physical page number and page offset) to the local memory hierarchy 118, along with the memory request. The memory hierarchy 118 then executes the memory access request using the physical address. If the memory access for the physical address is a hit, this indicates that the corresponding data is located in the memory hierarchy 118. Otherwise, if the memory access results in a miss, the memory hierarchy 118 retrieves, via the northbridge 125, the data corresponding to the physical address from the memory 150, stores the data at the physical address location, and executes the memory access request.

If the address translation module 121 identifies that the virtual memory address is located in a region of memory addresses corresponding to remapped data, the address translation module 121 identifies a remap rule for that address region. The remap rule indicates how the remapped data has been remapped. The address remapping engine 116 employs the remap rule to translate the virtual address to a remapped virtual address that indicates the location of the data after it has been remapped. The TLB 115 employs the remapped address in similar fashion to that described above to identify whether the data is stored at the local memory hierarchy 118.

If data corresponding to a remapped address is not stored at the memory hierarchy 118 it is provided, along with the physical address to the northbridge 125, which passes the memory access request to the memory 150 for retrieval of the corresponding data. The memory access request indicates that the request is for remapped data and indicates a data remap rule. In response, the data remap engine 128 remaps the data retrieved from the memory 150 and provide the remapped data to the memory hierarchy 118 for storage.

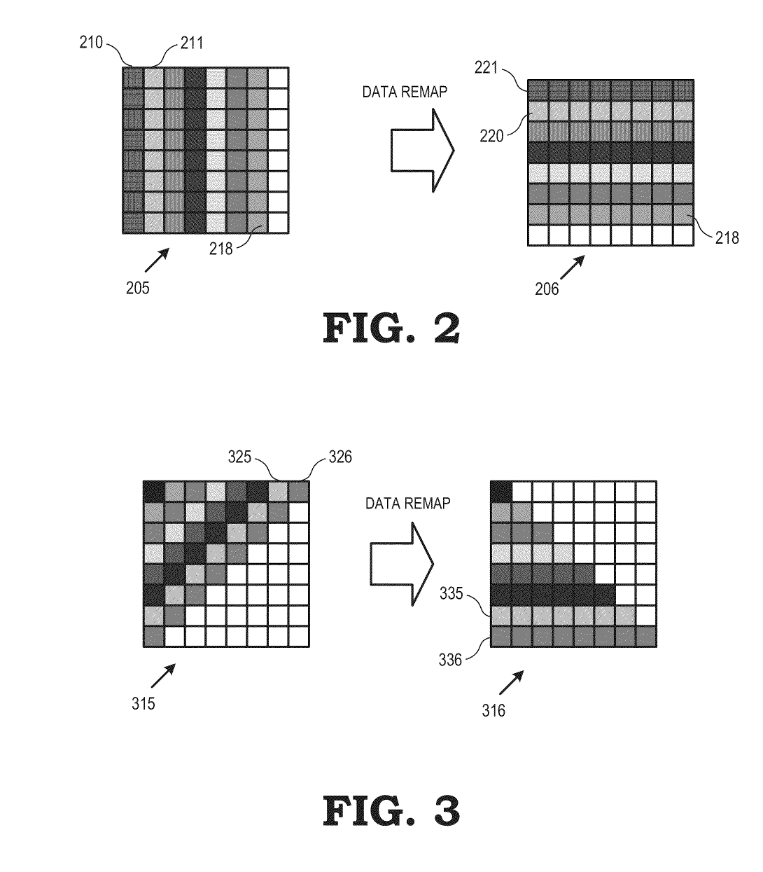

Remapping of data and addresses can be understood with references to FIGS. 2 and 3, which each show a corresponding example of data remapping in accordance with some embodiments. FIG. 2 illustrates data in a format 205 remapped to a format 206. In the illustrated example, the data includes a number of data segments, such as a segment 218, each illustrated by corresponding square. Each segment may correspond to a single bit of data, or may correspond to a larger data segment such as a byte, word or other size data segment. For example, in some embodiments each of the segments corresponds to an entry of an array or similar data structure. The format 205 is a column-based format, wherein the each segment of the stored data is stored in a columnar fashion. In contrast, in format 206 the same data is stored in a row-based fashion. That is, in format 205 contiguous segments of data are stored along columns, whereas in format 206 the same contiguous segments are stored in rows. Thus, in the illustrated example, format 205 includes a column 210 and a column 211. The data stored at these columns, when remapped into the row-based format of format 206, is stored at rows 220 and 221, respectively. That is row 220 stores the same data as column 210 and row 221 stores the same data as column 211.

The data remap engine 128 employs a data remap rule to remap the data from the format 205 to the format 206. This remapping changes the physical location of at least some of the data segments. Accordingly, the address remapping engine 116 is configured to remap the virtual addresses for the data segments so that the same virtual address can be used to locate the data segments at their new physical address locations. In some embodiments, the address remap rule can be expressed by the following equation

new_addr=height*(old_addr mod width)+(old_addr/width)

where old_addr is the address for a given segment of data in format 205, new_addr is the address for the same segment of data in format 206, height is the number of rows in format 205, and width is the number of columns in format 205. The data remap engine 128 can calculate the new address in other ways by remapping the data from each position (I,J) in the format 205, where I is the column of the corresponding data segment and J is the row of the corresponding data segment, to position (J,I) in format 206, where J is the column and I is the row of the corresponding data segment.

FIG. 3 illustrates another example of data remapping in accordance with some embodiments. In the illustrated example of FIG. 3, data is remapped from a “diagonal strip” format 315 to a row-based format 316. In the diagonal-strip format, units of data are organized along diagonals of memory segments (e.g. bit cells). Thus, data unit 326 is stored along on diagonal of the illustrated data segments, while data unit 325 is stored along another diagonal. After remapping, the data units are stored along rows of the illustrated memory segments. Thus, data unit 326 is stored at row 336, while data unit 325 is stored at row 335.

In some embodiments, the address remapping rule implemented by the address remap engine 116 to remap the addresses of the data from format 315 to the addresses of the data for format 316 is as follows:

new_addr=dim*(old_addr mod dim+old_addr/dim)+old_addr/dim

where old_addr is the address for a given segment of data in format 315, new_addr is the address for the same segment of data in format 316, and dim is the size of the rows and columns being remapped. The data remap engine 128 can calculate the new address in other ways by remapping the data from each position (I,J) in the format 315, where I is the column of the corresponding data segment and J is the row of the corresponding data segment, to position (J+I,I) in format 316, where J+I is the column and I is the row of the corresponding data segment.

It will be appreciated that the remappings illustrated at FIGS. 2 and 3 are examples, and that the processor 101 may implement any of a variety of remappings and corresponding remapping rules. For example, in some embodiments, the processor 101 may remap data from a row-major format to a column-major format, or vice-versa. In some embodiments, the processor 101 may remap data from a format having a given stride length, where the stride length represents a number of memory entries between data segments, to a format having a different stride length. In some embodiments, the processor 101 may remap data from a scatter format, wherein the data segments are located in disparate entries of memory, to a gather format, wherein the data segments are located in contiguous entries of memory, or vice-versa. In some embodiments, the processor 101 may remap data from a structure of arrays format to an array of structures format, or vice-versa.

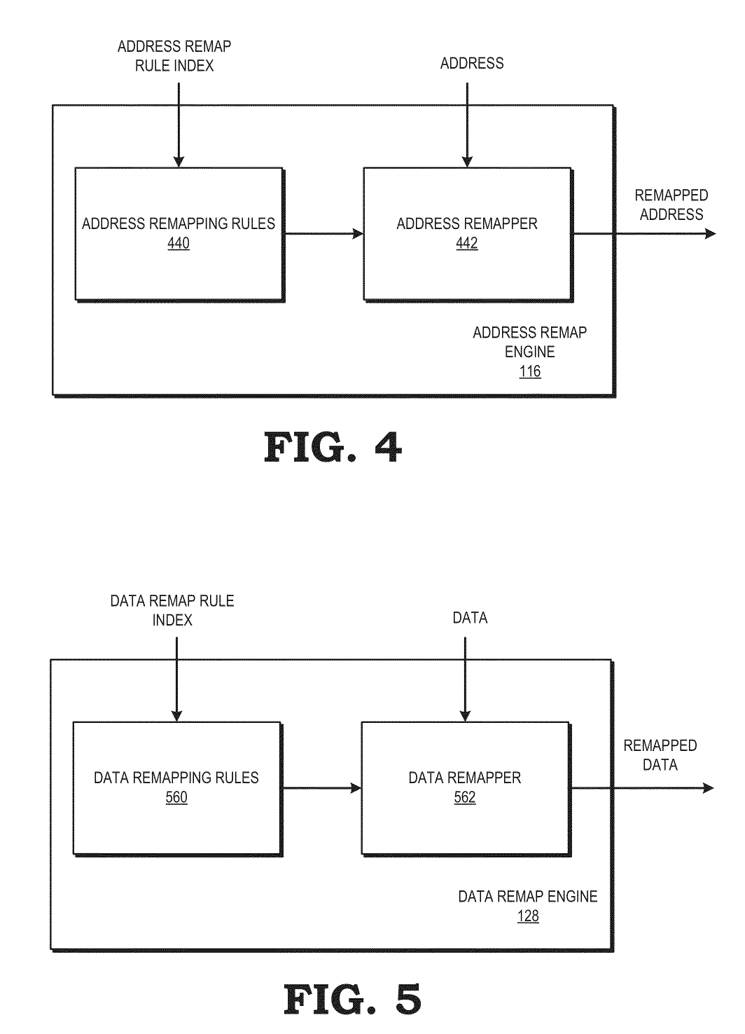

FIG. 4 illustrates a block diagram of the address remap engine 116 in accordance with some embodiments. In the illustrated example, the address remap engine 116 includes address remapping rules 440 and an address remapper 442. The address remapping rules 440 are recorded in a table or other data structure stored in a set of registers, a memory such as random access memory, or other storage structure. The data structure contains a number of indexed entries, with each entry including a different address remapping rule.

The address remapper 442 is a set of logic gates or other hardware devices configured to generate a remapped address based on a received virtual address and a received address remapping rule. The address remapping rule represents one or more equations that, when executed, transform the received virtual address, corresponding to data stored in a given format, to a remapped virtual address, representing the same data stored in a different format. The address remapper 442 interprets the received remapping rule and applies the received address to its logic gates or other hardware devices so that the equations represented by the address remapping rule are executed.

In operation, the address remap engine 116 receives an address remap rule index from the TLB 115, reflecting a stored address remap rule for a particular memory address or range of memory addresses (e.g. a memory page). For example, in some embodiments each entry of the TLB 115 includes a memory address and an address remap field to store an address remap rule index, indicating a predefined address remap rule for the corresponding address. In response to receiving the address remap rule index, the address remap engine 116 identifies the entry of the address remapping rules 440 corresponding to the index and provides the address remap rule stored at the identified entry to the address remapper 442. The address remapper 442 receives the address to be remapped from the TLB 115, and remaps the address according to the received address remap rule to generate the remapped address. The address remap engine 116 provides the remapped address to the TLB 115 for further processing, as described above with respect to FIG. 1.

FIG. 5 illustrates a block diagram of the data remap engine 128 in accordance with some embodiments. In the illustrated example, the data remap engine 128 includes data remapping rules 560 and a data remapper 562. The data remapping rules 560 are recorded in a table or other data structure stored in a set of registers, a memory such as random access memory, or other storage structure. The data structure contains a number of indexed entries, with each entry including a different data remapping rule.

The data remapper 562 is a set of logic gates or other hardware devices configured to generate remapped data based on a received data and a received data remapping rule. The data remapping rule represents one or more equations that, when executed, transform the storage layout of the received data from one format to a different format corresponding to a different storage layout. The data remapper 562 interprets the received remapping rule and applies the received data to its logic gates or other hardware devices so that the equations represented by the data remapping rule are executed.

In operation, the data remap engine 128 receives a data remap rule index from the memory hierarchy 118, reflecting a stored data remap rule for a particular memory address or range of memory addresses (e.g. a memory page). The data remap rule index can be included in the data access request, or can be stored an retrieved from a table of the data remap engine that stores data remap rule indexes for different memory address ranges. In response, the data remap engine 128 identifies the entry of the data remapping rules 560 corresponding to the index and provides the data remap rule stored at the identified entry to the data remapper 562. The data remapper 562 receives the data to be remapped from the memory 150, and remaps the data according to the received data remap rule to generate the remapped data. The data remap engine 128 provides the remapped address to the memory hierarchy 118 for storage and subsequent access by the GPU 104.

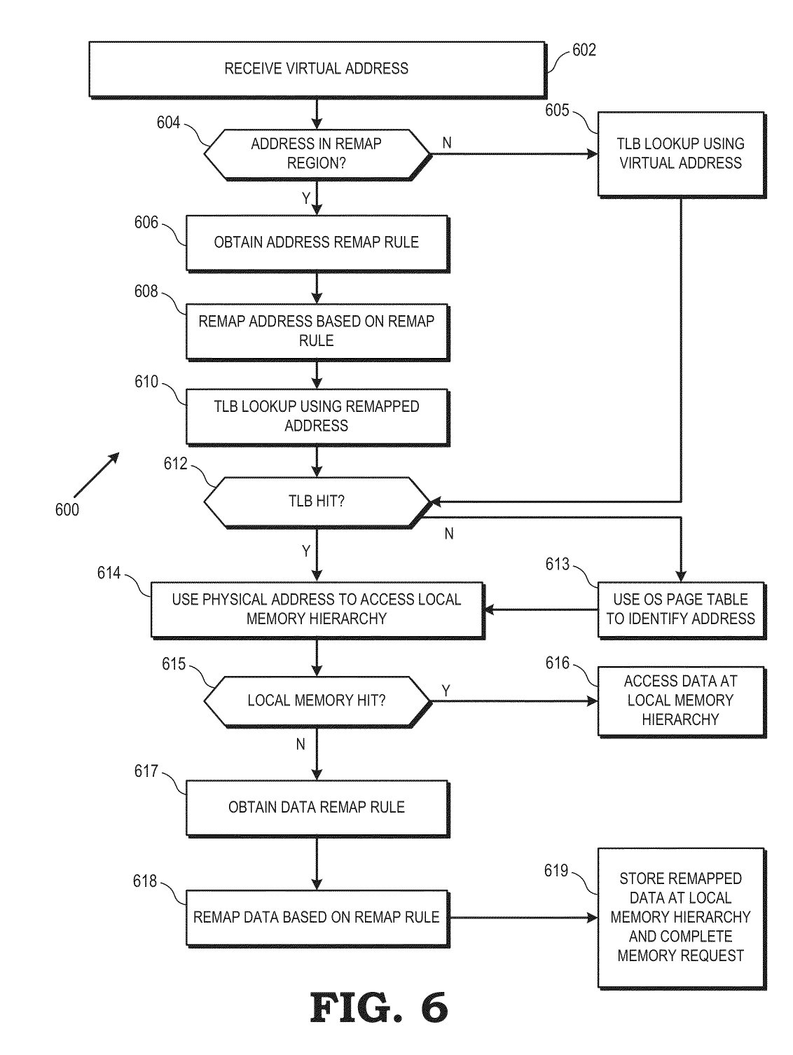

FIG. 6 illustrates a flow diagram of a method 600 of remapping data, and corresponding memory addresses, at a processor in accordance with some embodiments. For purposes of description, the method 600 is described with respect to an example implementation at the processing system 100 of FIG. 1. At block 602, the TLB 115 receives a virtual address, corresponding to the target address of a memory access request generated at the GPU 104. In response, at block 604 the TLB 115 identifies whether the received virtual address is within a “remap region”; that is, whether the received virtual addresses is within a region of memory addresses (such as a memory page or set of memory pages including more than one memory page) indicated as storing data that is to be remapped. If not, the method flow moves to block 605 and the TLB 115 determines whether it stores the received virtual address without remapping it. The method flow moves to block 612, described further below.

If, at block 604, the TLB 115 identifies the received virtual address as being within a remap region, the method flow moves to block 606 and the TLB 115 obtains the address remap rule corresponding to the identified region. Different regions of memory addresses (e.g. different memory pages) can have different remap rules. For example, one memory page can correspond to a remapping from a row-major to a column-major format, while another memory page can correspond to a remapping of data from a format having one stride length to a format having a different stride length.

At block 608, the address remap engine 116 remaps the received virtual address based upon the address remap rule obtained by the TLB 115. At block 610, the TLB 115 looks up whether it stores an address for a physical page corresponding to the remapped virtual page. If it does store such a physical page address, the TLB 115 indicates a TLB hit and the method flow moves to block 614, described below. If, at block 612 the TLB 115 determines that it does not store the physical page address, it indicates a TLB miss and the method flow moves to block 613, where the address translation module performs a page walk, using a set of operating system page tables, to identify the physical page of the virtual page (either the remapped virtual page from block 612, or the non-remapped virtual page from block 605). The method flow moves to block 614, where the TLB 115 provides the physical page address and the offset to the GPU's local memory hierarchy 118, and the memory hierarchy 118 identifies a physical address by adding the offset to the physical page address.

At block 615, the GPU's local memory hierarchy 118 identifies whether it stores data corresponding to the physical address identified at block 614. If so, the method flow moves to block 616 and the GPU's local memory hierarchy 118 satisfies the memory access request by accessing the data. If the GPU's local memory hierarchy 118 does not store data corresponding to the physical address, the method flow moves to block 617, where the physical address is provided, via the northbridge 125, to the memory 150, which retrieves the data at the physical address and provides it to the northbridge 125. At block 617 the data remap engine obtains the data remap rule index for the data from the address translation module 121 and, at block 618, remaps the retrieved data according to the data remap rule indicated by the index. At block 619, the memory hierarchy 118 stores the remapped data and completes the memory access request to the local memory hierarchy.

In some embodiments, the apparatus and techniques described above are implemented in a system comprising one or more integrated circuit (IC) devices (also referred to as integrated circuit packages or microchips). Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

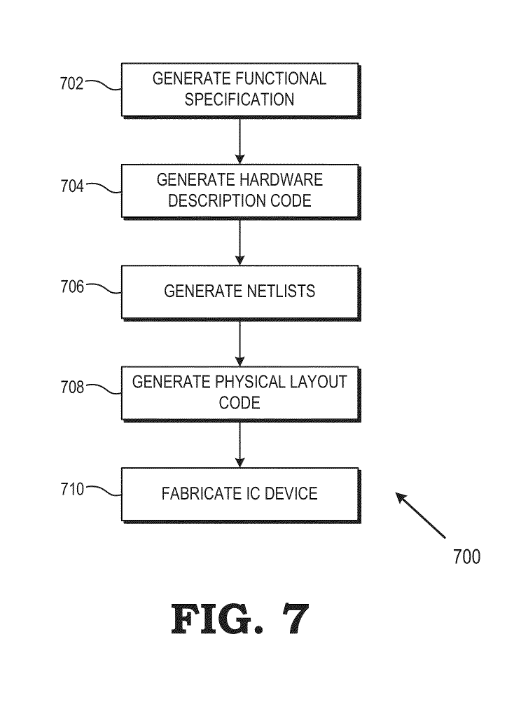

FIG. 7 is a flow diagram illustrating an example method 500 for the design and fabrication of an IC device implementing one or more aspects in accordance with some embodiments. As noted above, the code generated for each of the following processes is stored or otherwise embodied in non-transitory computer readable storage media for access and use by the corresponding design tool or fabrication tool.

At block 702 a functional specification for the IC device is generated. The functional specification (often referred to as a micro architecture specification (MAS)) may be represented by any of a variety of programming languages or modeling languages, including C, C++, SystemC, Simulink, or MATLAB.

At block 704, the functional specification is used to generate hardware description code representative of the hardware of the IC device. In some embodiments, the hardware description code is represented using at least one Hardware Description Language (HDL), which comprises any of a variety of computer languages, specification languages, or modeling languages for the formal description and design of the circuits of the IC device. The generated HDL code typically represents the operation of the circuits of the IC device, the design and organization of the circuits, and tests to verify correct operation of the IC device through simulation. Examples of HDL include Analog HDL (AHDL), Verilog HDL, SystemVerilog HDL, and VHDL. For IC devices implementing synchronized digital circuits, the hardware descriptor code may include register transfer level (RTL) code to provide an abstract representation of the operations of the synchronous digital circuits. For other types of circuitry, the hardware descriptor code may include behavior-level code to provide an abstract representation of the circuitry's operation. The HDL model represented by the hardware description code typically is subjected to one or more rounds of simulation and debugging to pass design verification.

After verifying the design represented by the hardware description code, at block 706 a synthesis tool is used to synthesize the hardware description code to generate code representing or defining an initial physical implementation of the circuitry of the IC device. In some embodiments, the synthesis tool generates one or more netlists comprising circuit device instances (e.g., gates, transistors, resistors, capacitors, inductors, diodes, etc.) and the nets, or connections, between the circuit device instances. Alternatively, all or a portion of a netlist can be generated manually without the use of a synthesis tool. As with the hardware description code, the netlists may be subjected to one or more test and verification processes before a final set of one or more netlists is generated.

Alternatively, a schematic editor tool can be used to draft a schematic of circuitry of the IC device and a schematic capture tool then may be used to capture the resulting circuit diagram and to generate one or more netlists (stored on a computer readable media) representing the components and connectivity of the circuit diagram. The captured circuit diagram may then be subjected to one or more rounds of simulation for testing and verification.

At block 708, one or more EDA tools use the netlists produced at block 706 to generate code representing the physical layout of the circuitry of the IC device. This process can include, for example, a placement tool using the netlists to determine or fix the location of each element of the circuitry of the IC device. Further, a routing tool builds on the placement process to add and route the wires needed to connect the circuit elements in accordance with the netlist(s). The resulting code represents a three-dimensional model of the IC device. The code may be represented in a database file format, such as, for example, the Graphic Database System II (GDSII) format. Data in this format typically represents geometric shapes, text labels, and other information about the circuit layout in hierarchical form.

At block 710, the physical layout code (e.g., GDSII code) is provided to a manufacturing facility, which uses the physical layout code to configure or otherwise adapt fabrication tools of the manufacturing facility (e.g., through mask works) to fabricate the IC device. That is, the physical layout code may be programmed into one or more computer systems, which may then control, in whole or part, the operation of the tools of the manufacturing facility or the manufacturing operations performed therein.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

As disclosed above, in some embodiments a method includes: in response to a request for data from a first processing unit of a processor, storing the data in a first format at a first local memory hierarchy of the first processing unit; and in response to a request for the data from a second processing unit of the processor, remapping the data to a second format different than the first format and storing the data in the second format at a second local memory hierarchy of the second processing unit. In some aspects, the method includes: in response to receiving a request to access the data at the second local memory hierarchy at a first address, remapping the first address to a second address and accessing the data at the second local memory based on the second address. In some aspects, remapping the first address to the second address comprises remapping the first address in response to identifying the first address is included in a first region of memory addresses. In some aspects, the first region of memory addresses is one or more memory pages. In some aspects, the method includes: generating the request for the data from the second processing unit in response to identifying that the data is not stored at the second local memory hierarchy based on the second address. In some aspects, the first format is a row-major format and the second format is a column-major format. In some aspects, the first format is an array of structures format and the second format is a structure of arrays format. In some aspects, the first format is a format associated with a first stride and the second format is a format associated with a second stride different from the first stride. In some aspects, wherein the first processing unit is a central processing unit and the second processing unit is a graphics processing unit. In some aspects, the first processing unit and the second processing unit use different instruction set architectures.

In some embodiments, a method includes: in response to receiving a request to access first data at a first local memory hierarchy at a first address, accessing the first data at the first local memory hierarchy at the first address; and in response to receiving a request to access the first data at a second local memory hierarchy at the first address, remapping the first address to a second address and accessing the first data at the second local memory based on the second address, the first local memory hierarchy and second local memory hierarchy associated with different processing units of a processor. In some aspects, remapping the first address to the second address comprises remapping the first address in response to identifying the first address is included in a first region of memory addresses. In some aspects, the method includes: in response to receiving a request to access second data at the second local memory hierarchy at a second address, and in response to identifying the second address is not included in the first region of memory addresses, accessing the second data at the second local memory hierarchy at the second address without remapping the second address. In some aspects, the method includes: in response to identifying that the first data is not stored at the second local memory hierarchy based on the second address: receiving the first data from memory in a first format; remapping the first data from the first format to a second format different from the first format; and storing the first data in the second format at the second local memory hierarchy.

In some embodiments, a processor includes: a first processing unit coupled to a first local memory hierarchy; a second processing unit coupled to a second local memory hierarchy; and a data remap engine to remap data stored in a first format at the first memory hierarchy to a second format different from the first format in response to a request for the data from the second processing unit. In some aspects, the request for the data comprises a first memory address, and further comprising: an address remap engine to remap the first address to a second address, the second processing unit to access the data at the second local memory hierarchy at a the second local memory hierarchy at the second address. In some aspects, the address remap engine is to remap the first address to the second address in response to identifying the first address is included in a first region of memory addresses. In some aspects, the first format is a row-major format and the second format is a column-major format. In some aspects, the first format is an array of structures format and the second format is a structure of arrays format. In some aspects, the first processing unit and the second processing unit use different types of instruction set architectures.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
in response to a request for data from a first processing unit of a processor, storing the data in a first format at a first local memory hierarchy of the first processing unit; and
in response to a request for the data from a second processing unit of the processor, remapping the data to a second format different than the first format and storing the data in the second format at a second local memory hierarchy of the second processing unit.

2. The method of claim 1, further comprising:
in response to receiving a request to access the data at the second local memory hierarchy at a first address, remapping the first address to a second address and accessing the data at the second local memory based on the second address.

3. The method of claim 2, wherein remapping the first address to the second address comprises remapping the first address in response to identifying the first address is included in a first region of memory addresses.

4. The method of claim 3, wherein the first region of memory addresses is one or more memory pages.

5. The method of claim 2, further comprising:
generating the request for the data from the second processing unit in response to identifying that the data is not stored at the second local memory hierarchy based on the second address.

6. The method of claim 1, wherein the first format is a row-major format and the second format is a column-major format.

7. The method of claim 1, wherein the first format is an array of structures format and the second format is a structure of arrays format.

8. The method of claim 1, wherein the first format is a format associated with a first stride and the second format is a format associated with a second stride different from the first stride.

9. The method of claim 1, wherein the first processing unit is a central processing unit and the second processing unit is a graphics processing unit.

10. The method of claim 1, wherein the first processing unit and the second processing unit use different instruction set architectures.

11. A method implemented at a processor, comprising:
in response to receiving a request to access first data at a first local memory hierarchy at a first address, accessing the first data at the first local memory hierarchy at the first address; and
in response to receiving a request to access the first data at a second local memory hierarchy at the first address, remapping the first address to a second address and accessing the first data at the second local memory based on the second address, the first local memory hierarchy and second local memory hierarchy associated with different processing units of a processor.

12. The method of claim 11, wherein remapping the first address to the second address comprises remapping the first address in response to identifying the first address is included in a first region of memory addresses.

13. The method of claim 12, further comprising:
in response to receiving a request to access second data at the second local memory hierarchy at a second address, and in response to identifying the second address is not included in the first region of memory addresses, accessing the second data at the second local memory hierarchy at the second address without remapping the second address.

14. The method of claim 11, further comprising:
in response to identifying that the first data is not stored at the second local memory hierarchy based on the second address:
receiving the first data from memory in a first format;
remapping the first data from the first format to a second format different from the first format; and
storing the first data in the second format at the second local memory hierarchy.

15. A processor, comprising:
a first processing unit coupled to a first local memory hierarchy;
a second processing unit coupled to a second local memory hierarchy; and
a data remap engine to remap data stored in a first format at the first memory hierarchy to a second format different from the first format in response to a request for the data from the second processing unit.

16. The processor of claim 15, wherein the request for the data comprises a first memory address, and further comprising:
an address remap engine to remap the first address to a second address, the second processing unit to access the data at the second local memory hierarchy at a the second local memory hierarchy at the second address.

17. The processor of claim 16 wherein the address remap engine is to remap the first address to the second address in response to identifying the first address is included in a first region of memory addresses.

18. The processor of claim 15, wherein the first format is a row-major format and the second format is a column-major format.

19. The processor of claim 14, wherein the first format is an array of structures format and the second format is a structure of arrays format.

20. The processor of claim 14, wherein the first processing unit and the second processing unit use different types of instruction set architectures.
